(19) United States
(12) Patent Application Publication
(10) Pub. No.: US 2020/0324741 A1
(43) Pub. Date: Oct. 15, 2020

(54) Jack Stabilizer Apparatus

(71) Applicant: Mike John Gledhill, Newmarket (CA)

(72) Inventor: Mike John Gledhill, Newmarket (CA)

(21) Appl. No.: 16/383,769

(22) Filed: Apr. 15, 2019

(51) Int. Cl. B60S 9/02

(52) U.S. Cl. CPC B60S 9/02; B60P 3/32

(57) ABSTRACT

A jack stabilizing apparatus that is operably coupled intermediate a scissor jack and a portion of a frame of a recreational trailer and is configured to substantially inhibit movement of the recreational trailer ensuing being lifted by the scissor jack. The jack stabilizing apparatus includes a coupling member that is secured to the scissor jack. A frame attachment member is operably coupled to the frame of the recreational trailer. A support arm is intermediate the coupling member and the frame attachment member and operably coupled to each. The support member includes a first portion and a second portion that are slidably coupled so as to provide length adjustment thereof. The frame attachment member is provided in several alternative embodiments so as to be operably coupled to either a box style frame or an i-beam style frame of a recreational trailer.

### FIELD OF THE INVENTION

The present invention relates generally to a vehicle stabilization apparatus, more specifically but not by way of limitation, a vehicle or trailer stabilization apparatus that is operably coupled to a jack wherein the stabilization apparatus inhibits movement of the lifted vehicle/trailer subsequent the jack lifting the vehicle/trailer to a position such that the wheels thereof are no longer engaged with the ground.

### BACKGROUND

Recreational vehicles have grown in popularity over the last several decades. As is known in the art there are alternate types of classifications of recreational vehicles such as but not limited to motor homes or camper trailers. The aforementioned are utilized by millions for recreational activities such as but not limited to camping. With specific reference to camper trailers, these types of recreational vehicles are typically towed utilizing a suitable tow vehicle such as a truck and are parked in desired locations for periods of time wherein the tow vehicle is disconnected therefrom. When a recreational camper trailer is parked and disconnected from its tow vehicle, the standard procedure is to block the tires and lift the trailer on jacks such as but not limited to conventional scissor jacks. This is done to ensure the stability of the trailer once disconnected from the tow vehicle and further prevent damage to the tires while parked for long periods of time.

While parked and in use the camping trailer is often susceptible to movements on the jacks on which the camping trailer is lifted. As the tires of the camping trailer are no longer engaged the stability of the trailer is reduced and as such when individuals are inside the trailer their movement within results in movement of the trailer. This movement can create an insecure feeling for the individuals within the camping trailer as well as potentially dislodge the camping trailer from the jacks should the movements be significant. Conventional lifting jacks provide one engagement point with the frame of the object they are lifting and are typically narrow in stance. The two aforementioned parameters result in an insufficient lateral stability and as such permit movement of the vehicle/trailer that is lifted.

Accordingly, there is a need for a jack stabilizer apparatus that is configured to be operably coupled to a jack such as but not limited to a scissor jack and further be coupled to the frame of the object being lifted wherein the present invention inhibits movement of the object being lifted by the jack.

### SUMMARY OF THE INVENTION

It is the object of the present invention to provide a jack stabilizing apparatus that is configured to inhibit movement of a recreational vehicle trailer subsequent being lifted by a jack wherein the present invention is operably coupled intermediate a conventional scissor jack and the frame of the recreational vehicle trailer.

Another object of the present invention is to provide a recreational vehicle stabilizing apparatus that is operable to inhibit movement of the recreational vehicle subsequent the lifting thereof by a lifting jack wherein the present invention includes a coupling member operably secured to the base plate of the lifting jack.

A further object of the present invention is to provide a jack stabilizing apparatus that is configured to inhibit movement of a recreational vehicle trailer subsequent being lifted by a jack wherein the present invention includes a support arm extending intermediate the coupling member and the frame.

Still another object of the present invention is to provide a recreational vehicle stabilizing apparatus that is operable to inhibit movement of the recreational vehicle subsequent the lifting thereof by a lifting jack that further includes a frame attachment member operably coupled to the support arm distal the coupling member.

An additional object of the present invention is to provide a jack stabilizing apparatus that is configured to inhibit movement of a recreational vehicle trailer subsequent being lifted by a jack wherein the present invention includes alternative embodiments of the frame attachment member.

Yet a further object of the present invention is to provide a recreational vehicle stabilizing apparatus that is operable to inhibit movement of the recreational vehicle subsequent the lifting thereof by a lifting jack wherein the alternative embodiments of the frame attachment member are configured to releasably secure to various types of frames of recreational vehicle trailers.

Another object of the present invention is to a provide a jack stabilizing apparatus that is configured to inhibit movement of a recreational vehicle trailer subsequent being lifted by a jack wherein the support arm includes a first portion and a second portion.

An alternate object of the present invention is to provide a recreational vehicle stabilizing apparatus that is operable to inhibit movement of the recreational vehicle subsequent the lifting thereof by a lifting jack wherein the first portion and second portion of the support arm are slidably coupled.

Still a further object of the present invention is to provide a jack stabilizing apparatus that is configured to inhibit movement of a recreational vehicle trailer subsequent being lifted by a jack wherein the first portion and second portion are configured to be releasably secured in numerous alternate positions with respect to each other.

An additional object of the present invention is to provide a recreational vehicle stabilizing apparatus that is operable to inhibit movement of the recreational vehicle subsequent the lifting thereof by a lifting jack wherein the support arm is configured to extend and/or compress as the jack is lifted or contracted.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of the present invention installed on an exemplary recreational vehicle trailer; and

FIG. 2 is a side view of the present invention in its stowed position; and

FIG. 3 is a side view of the present invention in transition to its deployed position; and

FIG. 4 is a side view of the present invention in transition to its deployed position; and

FIG. 5 is a side view of the present invention in transition to its deployed position; and

FIG. 6 is a side view of the present invention in transition to its deployed position; and

FIG. 7 is a side view of the present invention in its deployed position; and

FIG. 8 is a detailed side view of the coupling member of the of the present invention; and

FIG. 9 is an end view of an embodiment of the frame attachment member of the present invention; and

FIG. 10 is a side view of an embodiment of the frame attachment member of the present invention; and

FIG. 11 is a side view of an embodiment of the frame attachment member of the present invention; and

FIG. 12 is a side view of an embodiment of the frame attachment member of the present invention; and

FIG. 13 is an end view of an embodiment of the frame attachment member of the present invention; and

FIG. 14 is a detailed view of a support member of an embodiment of the frame attachment member of the present invention; and

FIG. 15 is an end view of an embodiment of the frame attachment member of the present invention; and

FIG. 16 is a detailed view of a frame attachment member of the present invention.

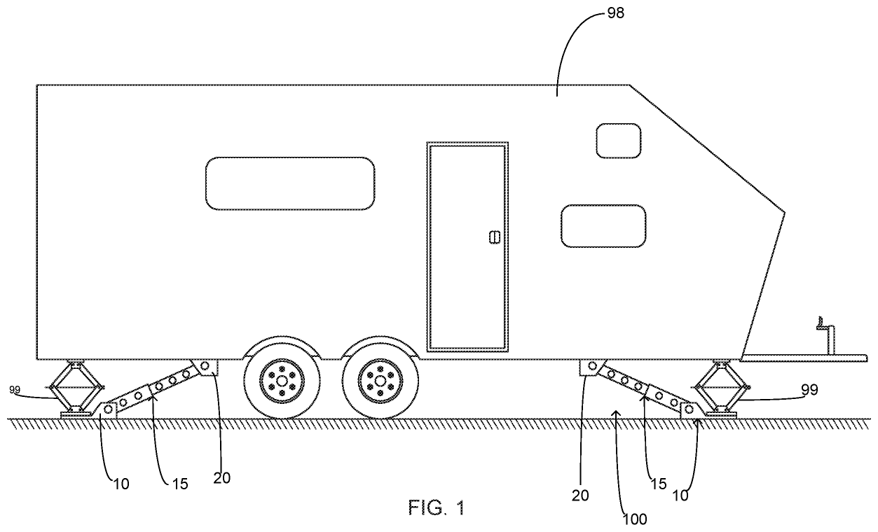

### DETAILED DESCRIPTION

Referring now to the drawings submitted herewith, wherein various elements depicted therein are not necessarily drawn to scale and wherein through the views and figures like elements are referenced with identical reference numerals, there is illustrated a jack stabilizer apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

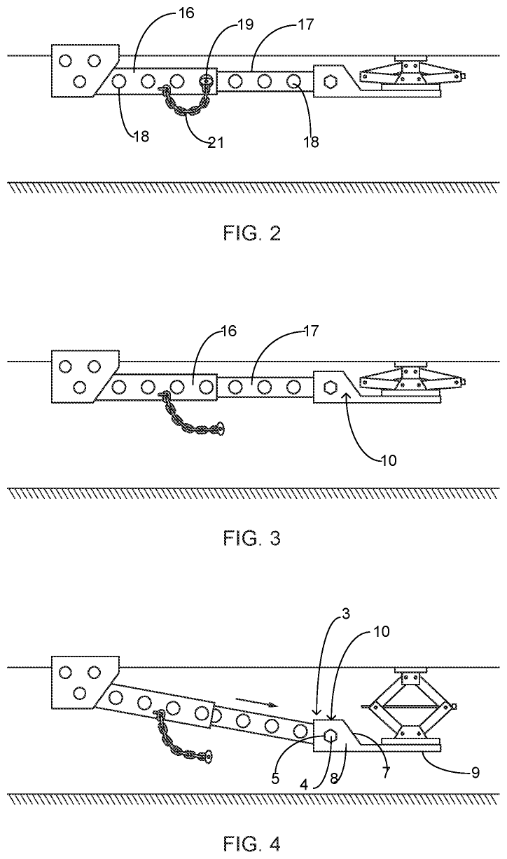

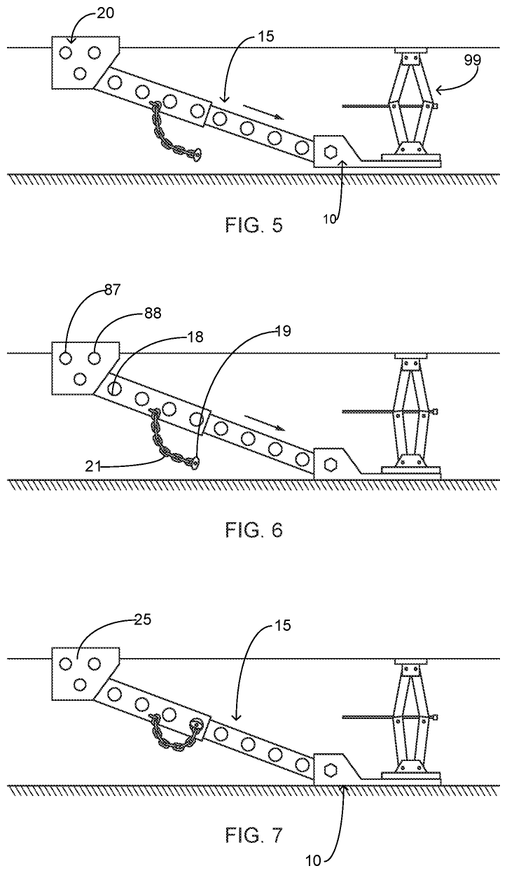

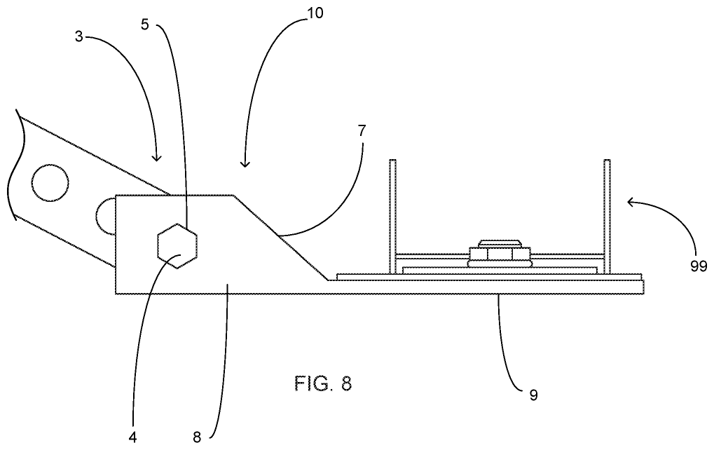

Now referring in particular to the Figures submitted herewith, the jack stabilizer apparatus 100 includes a coupling member 10, a support arm 15 and a frame attachment member 20 that are operably coupled intermediate an exemplary scissor jack 99 and frame of an exemplary recreational trailer 98. The jack stabilizer apparatus 100 in its deployed position is operable to inhibit movement of the recreational trailer 98 and ensure stability of the scissor jacks 99. The jack stabilizer apparatus 100 is movable intermediate a stowed position, illustrated herein in FIG. 2, and a deployed position, illustrated herein in FIG. 7. FIG. 2 through FIG. 7 illustrate the jack stabilizer apparatus 100 being moved intermediate its stowed position to its deployed position. The jack stabilizer apparatus 100 is manufactured from a durable rigid material such as but not limited to carbon steel. It should be understood within the scope of the present invention that while two jack stabilizer apparatus 100 are illustrated herein for use on a recreational trailer 98, that as few as one jack stabilizer apparatus 100 could be deployed or more than two.

The jack stabilizer apparatus 100 includes support arm 15. Support arm 15 includes a first portion 16 and a second portion 17. The first portion 16 and second portion 17 are manufactured from square metal tubing and are provided in a sufficient length to ensure the ability to provide movement of the jack stabilizer apparatus 100 intermediate its stowed position and its deployed position. The second portion 17 is slidably inserted into the first portion 16 and is movable in the interior volume thereof. The first portion 16 and second portion 17 include a plurality of apertures 18 wherein the apertures 18 are formed on opposing sidewalls of the first portion 16 and second portion 17. It should be understood within the scope of the present invention that the first portion 16 and second portion 17 could have various quantities of apertures 18 formed therein. The apertures 18 of the first portion 16 and second portion 17 are configured to align so as to receive pin 19 therethrough. Pin 19 is a conventional metal pin and is operable to be journaled through aligned apertures 18 of the first portion 16 and second portion 17 in order to adjust the length of the support arm 15 to a desired position. The support arm 15 is adjustable to alternate lengths so as to adapt to various heights of recreational trailers 98. The pin 19 is retained in position with keeper 21. While keeper 21 is illustrated herein as a chain, it is contemplated within the scope of the present invention that the keeper 21 could be manufactured from alternate suitable materials such as but not limited to metal cable.

The coupling member 10 provides an operable connection intermediate the support arm 15 and the exemplary scissor jack 99. The coupling member 10 is manufactured from a durable rigid material such as but not limited to metal. Coupling member 10 includes a base plate 9 contiguously formed with sidewall members 8. While not particularly illustrated herein, the coupling member 10 includes a sidewall member on opposing sides of the base plate 9 forming a void therebetween being of suitable size to receive end 3 of support arm 15 therein. The sidewall member 8 is planar in manner and extends upward from the base plate 9 and further includes angular front edge 7. Angular front edge 7 is provided to ensure lack of interference with the scissor jack 99 during operation thereof. The end 3 of support arm 15 is pivotally connected to the sidewall member 8 utilizing fastener 4 that is journaled through hole 5. The base plate 9 is secure to scissor jack 99 utilizing suitable techniques such as but not limited to welding or mechanical fasteners.

Illustrated herein in FIG. 15 is an embodiment of the frame attachment member 20. As will be further discussed herein, the jack stabilizer apparatus 100 includes alternate embodiments of the frame attachment member 20 wherein the embodiments are configured to provide an operable connection with different styles of frames such as but not limited to box frames and i-beam frames of the recreational trailer 98. The frame attachment member 20 includes opposing side plate support members 25, 26. The opposing side plate support members 25, 26 have operably coupled intermediate thereto and perpendicular therewith support member 27. The opposing side plate support members 25, 26 include upper portions 31,32 and lower portions 33, 34 that are contiguously formed. The upper portions 31,32 have void therebetween that is configured to receive frame portion 97. The upper portions 31, 32 are secured to the frame portion 97 utilizing fasteners 96. The lower portions 33,34 extend downward from support member 27 and have void therebetween that is operable to receive an end 11 of support arm 15. End 11 is rotatably coupled to the lower portions 33,34 utilizing fastener 93 wherein the fastener 93 is journaled through the opposing lower portions 33, 34 and the end 11. Referring in particular to FIG. 16 herein, a side plate support member 25 is illustrated therein. The side plate support member 25 includes hole 92 that is configured to receive fastener 93. Holes 87,88 are configured to receive therein fastener 96. It should be understood within the scope of the present invention that the side plate support members 25, 26 could be provided with two holes 87,88 for fasteners 96 or an alternate quantity thereof could be provided.

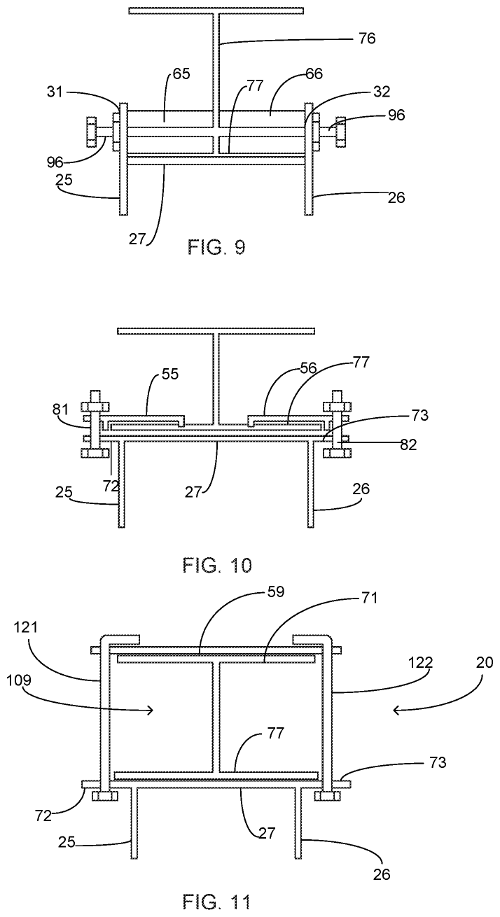

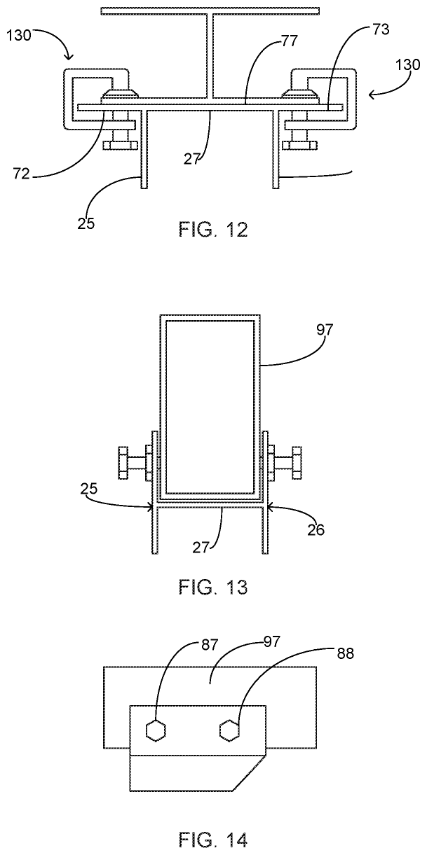

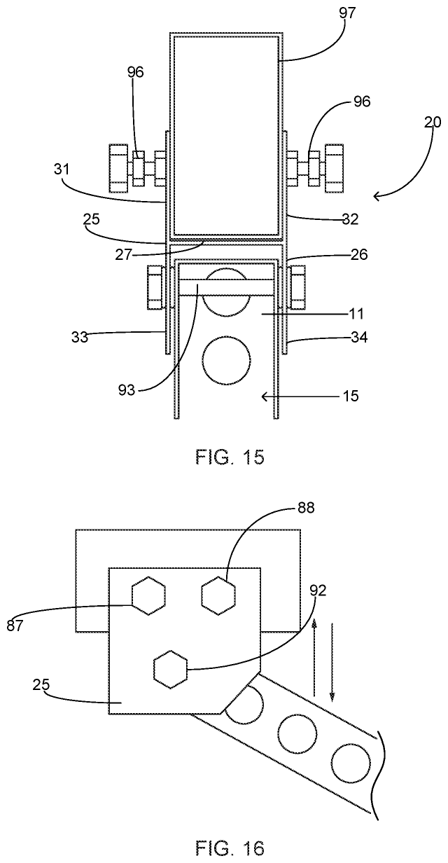

FIGS. 9 through 12 provide detailed views of an embodiment of the frame attachment member 20 wherein the embodiments therein are configured to secure to an i-beam style frame. All embodiments include support member 27 and side plate support members 25, 26 that are configured as previously described herein. Referring in particular to FIG. 9 the embodiment of the frame attachment member 20 illustrated therein includes upper portions 31,32 extending upward from support member 27. The upper portions 31,32 extend upward from frame portion 77 and are parallel with frame section 76. Opposing spacers 65,66 are intermediate upper portions 31,32 and frame section 76. Fasteners 96 are operably coupled through spacers 65, 66 wherein spacers 65,66 provide additional structural integrity for the frame attachment member 20.

Illustrated herein in FIG. 10 is another alternative embodiment of the frame attachment member 20. As illustrated therein a pair of opposing pinch plate members 55,56 are provided to operably couple to frame portion 77. Pinch plate members 55, 56 are operably coupled to wing support members 72,73 using fasteners 81,82. Wing support members 72,73 extend outward from side plate support members 25,26 and are perpendicular thereto. The pinch plate members 55,56 function to bias frame portion 77 intermediate the support member 27 and the pinch plate members 55,56 upon tightening of fasteners 81,82.

Still a further alternative embodiment of the frame attachment member 20 is illustrated in FIG. 11 herein. The frame attachment member 20 includes an upper support plate 59 that is superposed frame portion 71. The upper support plate 59 includes sections thereof that extend beyond the edges of frame portion 71. Frame section 109 is biased intermediate upper support plate 59 and support member 27 utilizing fasteners 121,122. Fasteners 121,122 are illustrated herein as being l-shaped but it is contemplated within the scope of the present invention that the fasteners 121,122 could be provided in alternate styles and still achieve the desired objective of operably securing the support member 27 with the upper support plate 59 so as to bias frame section 109 therebetween.

Illustrated herein in FIG. 12 is an embodiment of the frame attachment member 20 wherein alternate fasteners 130 are deployed to facilitate the operable coupling of the support member 27 with frame portion 77. Fasteners 130 are c-style fasteners that are operable to secure wing support members 72,73 to frame portion 77. While alternate embodiments of the frame attachment member 20 have been illustrated herein, it is contemplated within the scope of the present invention that the frame attachment member 20 could further include additional configurations that are operable to provide securement to a frame of a recreational vehicle and a rotatable connection with support arm 15.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A jack stabilizing apparatus configured to inhibit movement of an object lifted by a jack comprising:
a support arm, said support arm having a first portion and a second portion, said first portion and said second portion being movably coupled, said support arm having a first end and a second end;
a coupling member, said coupling member being secured to a jack, said coupling member being configured to be movably coupled to said first end of said support arm;
a frame attachment member, said frame attachment member being operably coupled to a portion of a frame of the object being lifted by the jack, said frame attachment member further including a portion configured to be movably coupled to said second end of said support arm; and
wherein said support arm extends intermediate the coupling member and the frame attachment member in an angular manner so as to provide engagement of the object at an additional point from the jack in order to inhibit movement of the object.

2. The jack stabilizing apparatus as recited in claim 1, wherein said coupling member further includes a base plate, said base plate being mounted underneath the jack, said base plate having a portion extending outward from the jack.

3. The jack stabilizing apparatus as recited in claim 2, wherein the coupling member further includes opposing sidewall members, said sidewall members extending upward from the portion of said base plate extending outward from the jack, said sidewall members having a void therebetween configured to receive said first end of said support arm.

4. The jack stabilizing apparatus as recited in claim 3, wherein said frame attachment member further includes a support member, said support member being adjacent a portion of a frame of the object.

5. The jack stabilizing apparatus as recited in claim 4, wherein said frame attachment member includes a pair of side plate support members, said side plate support members formed on opposing sides of the support member, said side plate support members extending downward from said support member and having a void therebetween to receive said second end of said support arm.

6. The jack stabilizing apparatus as recited in claim 5, wherein said first portion and said second portion of said support arm include a plurality of apertures, said plurality of apertures operable to provide length adjustment of said support arm in conjunction with a pin journaled therethrough.

7. The jack stabilizing apparatus as recited in claim 6, wherein the jack stabilizing apparatus is movable intermediate a stowed and deployed position wherein in the stowed position the jack stabilizing apparatus is adjacent a frame of the object.

8. A jack stabilizing apparatus that is operable to inhibit directional movement of a recreational trailer that has been lifted by a scissor jack wherein the jack stabilizing apparatus comprises:
a support arm, said support arm having a first portion and a second portion, said first portion and said second portion being slidably coupled, said second portion being partially inserted into said first portion, said first portion and said second portion having a plurality of apertures, said support arm having a first end and a second end;
a coupling member, said coupling member being secured to a jack, said coupling member having a base plate, said base plate being mounted underneath the jack, said base plate having a portion extending outward from the jack, said portion of said base plate having sidewall members extending upward therefrom forming a void therebetween, said void configured to receive said first end of said support arm;
a frame attachment member, said frame attachment member being operably coupled to a portion of a frame of the object being lifted by the jack, said frame attachment member having a support member, said support member being planar in manner, said support member being adjacent a portion of a frame of the recreational trailer, said frame attachment member further including a portion extending downward from said support member configured to be movably coupled to said second end of said support arm; and
wherein the jack stabilizing apparatus is movable intermediate a stowed and deployed position wherein in the stowed position the support arm is adjacent a portion of the frame of the recreational vehicle.

9. The jack stabilizing apparatus as recited in claim 8, wherein said portion of said frame attachment member extending downward from said support member includes opposing side plate support members, said side plate support members having a void therebetween sufficient in size to accommodate said second end of said support arm.

10. The jack stabilizing apparatus as recited in claim 9, wherein said frame attachment member is configured to operably couple said second end of said support arm to a frame selected from one of the following frame types: a box frame or an i-beam frame.

11. The jack stabilizing apparatus as recited in claim 10, wherein said frame attachment member further includes a pair of opposing upper portions, said pair of opposing upper portions extending upward from opposing sides of said support member.

12. The jack stabilizing apparatus as recited in claim 11, and further including wing support members, said wing support members being contiguous with said support member of the frame attachment and extending outward therefrom.

13. The jack stabilizing apparatus as recited in claim 12, and further including a pair of pinch plate members, said pinch plate members being mechanically secured to said wing support members, said pinch plate members configured to bias against a portion of a i-beam style frame opposite said support member of the frame attachment.

14. The jack stabilizing apparatus as recited in claim 13, wherein said opposing side plate support members include holes journaled therethrough for receiving a fastener to movably secure said second end of said support arm.

15. A jack stabilizing apparatus that is operable to inhibit directional movement of a recreational trailer that has been lifted by a scissor jack wherein the jack stabilizing apparatus comprises:
a support arm, said support arm being manufactured from square metal tubing, said support arm having a first portion and a second portion, said first portion and said second portion being slidably coupled, said second portion being partially inserted into said first portion, said first portion and said second portion having a plurality of apertures, said support arm having a first end and a second end, said support arm being adjustable in length utilizing a pin journaled through aligned apertures of said first portion and said second portion;
a coupling member, said coupling member being secured to a jack, said coupling member having a base plate, said base plate being mounted underneath the jack, said base plate having a portion extending outward from the jack, said portion of said base plate having sidewall members extending upward therefrom forming a void therebetween, said sidewall members having a leading edge being angular in manner, said void configured to receive said first end of said support arm;
a frame attachment member, said frame attachment member being operably coupled to a portion of a frame of the object being lifted by the jack, said frame attachment member having a support member, said support member being planar in manner, said support member being adjacent a portion of a frame of the recreational trailer, said frame attachment member further including opposing side plate members extending downward therefrom, said opposing side plate members having a void therebetween configured to receive said second end of said support arm therein; and
wherein the jack stabilizing apparatus is movable intermediate a stowed and deployed position wherein in the stowed position the support arm is adjacent a portion of the frame of the recreational vehicle.

16. The jack stabilizing apparatus as recited in claim 15, and further including wing support members, said wing support members being contiguous with said support member of the frame attachment and extending outward therefrom on opposing sides of said support member.

17. The jack stabilizing apparatus as recited in claim 16, and further including an upper support plate, said upper support plate being opposedly located on the frame of the recreational trailer from said support member, said support member and said upper support plate being mechanically coupled so as to bias the frame therebetween.

18. The jack stabilizing apparatus as recited in claim 16, and further including a pair of pinch plate members, said pinch plate members being mechanically secured to said wing support members, said pinch plate members configured to bias against a portion of a i-beam style frame opposite said support member of the frame attachment.

19. The jack stabilizing apparatus as recited in claim 16, wherein said frame attachment member further includes a pair of spacers, said spacers being intermediate a central portion of a i-beam frame an opposing upper portions of the frame attachment member.

20. The jack stabilizing apparatus as recited in claim 15, wherein said frame attachment member is configured to operably couple said second end of said support arm to a frame selected from one of the following frame types: a box frame or an i-beam frame.
